(19) United States
(12) Patent Application Publication
(10) Pub. No.: US 2001/0054111 A1
(43) Pub. Date: Dec. 20, 2001

(54) Wireless information service system using bar code and method therefor

(76) Inventors: You-hyun Lee, Seongnam-City (KR); Kee-hwan Lee, Seoul (KR); Sun-jung Kim, Seoul (KR); Min-gyun Jeong, Seoul (KR); Gwi-ho Lee, Seoul (KR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/794,162

(22) Filed: Feb. 28, 2001

(30) Foreign Application Priority Data
Jun. 13, 2000 (KR) 00-32387

(51) Int. Cl. G06F 15/16; G06F 7/00; G06F 17/00

(52) U.S. Cl. 709/245; 709/203; 707/104.1

(57) ABSTRACT

A system and method for providing information services using a bar code at a wireless terminal, which is capable of receiving a variety of information services including user authentication through a network by receiving a bar code from a wireless terminal over the Internet and reading the transmitted bar code from a bar code system of a member store. The bar code system is constructed such that various services may be offered through a bar code system associated with a bar code issue server using a bar code transmitted to the wireless terminal through the Internet. Accordingly, the information service system and method are provided for various on line business services while not substantially modifying conventional bar code systems. Also, a bar code service can be offered through the wireless terminal, thereby allowing for excellent mobility compared with the conventional bar code system. Additionally, a marketing database for integrally managing information through a single bar code issue server can be provided. Moreover, an enterprise can easily handle various authentication procedures through an on line network.

### BACKGROUND OF THE INVENTION

1. Field of the Invention

The present invention relates to a system and method for providing information services over a network, and more particularly, to an information service system using a bar code which is capable of receiving a variety of information services including user authentication through a network by receiving a bar code from a wireless terminal over the Internet and reading the transmitted bar code from a bar code system of a member store. This application is based on Korean Patent Application No. 00-32387, filed on Jun. 13, 2000, which is incorporated herein by reference.

2. Description of the Related Art

Bar code systems are mainly introduced into large sized supermarkets or department stores in order to effectively manage sales and distribution of goods. To assess and manage the status of distribution of goods, bar code systems assign a bar code typical of the relevant goods and tabulate information related to the relevant goods such as inventories, prices, and manufacturers corresponding to the bar code, and store the same information in a database. Then, the bar code system interprets a bar code read by a bar code reader, retrieves requested information from a corresponding database, and transmits appropriate information to a monitor of the bar code reader while updating transaction content and storing it in the database.

Since the conventional bar code system can be utilized only within a predetermined area connected through a wired network, it not only offers low mobility but also can not utilize a variety of applications such as personal information services, couponing services, and membership services.

### SUMMARY OF THE INVENTION

To solve the above problems, it is an objective of the present invention to provide an information service system which uses a bar code and which allows for a wide variety of business activities. The information service system receives information in a bar code form through a wireless terminal using the Internet and checks the bar code transmitted by the wireless terminal in a bar code system of a member store.

Accordingly, to achieve the above objective, the present invention provides a bar code issue server for providing a bar code service over a network including a database for storing subscriber information and bar code service information pertaining to the subscriber. The network also includes a web server for transmitting to a terminal requesting the bar code related service the result processed in response to information transmitted over the network. The results are transmitted to a terminal that requests the bar code-related service by a transmission protocol commonly used on the network. The network further includes a bar code generator for generating a bar code corresponding to the information requested by the terminal, and a controller for managing the database and controlling a system such that the controller analyzes the bar code related service request information to generate a bar code related to the subscriber or executes an authentication process for a received bar code.

The present invention also provides an information service method using a bar code from a bar code issue server over a network including the steps of: (a) receiving data related to a request to issue a bar code corresponding to predetermined service information from a terminal connected to the bar code issue server; (b) analyzing the information requested in the step (a) to generate a bar code corresponding to the analyzed result; and (c) transmitting the bar code generated in the step (b) to a terminal that sends the request to issue the bar code.

### BRIEF DESCRIPTION OF THE DRAWINGS

The above objective(s) and advantages of the present invention will become more apparent by describing in detail a preferred embodiment thereof with reference to the attached drawings in which:

FIG. 1 shows the configuration of a typical network, and explains a typical contemplated business concept according to the present invention;

FIG. 2 shows the configuration of an information service system using a bar code according to the present invention; and

FIG. 3 is a flowchart showing an information service method according to the present invention.

### DETAILED DESCRIPTION OF THE INVENTION

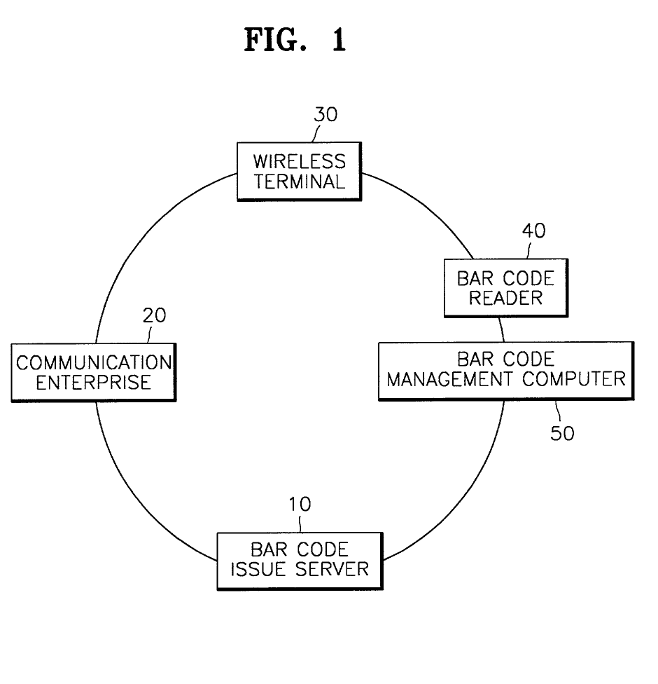

Referring to FIG. 1, an Internet business model according to the present invention is proposed for providing for a wide variety of business services using a bar code, wherein a bar code issue server 10, a communication enterprise 20, a wireless terminal 30, a bar code reader 40, and a bar code management computer 50 are linked together in a network. That is, in a business model according to the present invention, the bar code issue server 10 transmits bar code data in response to corresponding requested information to the wireless terminal 30 through the communication enterprise 20 in response to the user's request. A corresponding bar code is then output through a display device of the wireless terminal 30 of the user, and the bar code output to the user's wireless terminal 30 is read by a bar code reader 40 at a member store corresponding with bar code issue server 10. The read bar code is then interpreted by the bar code management computer 50 included in a central system of the bar code member store. The bar code management computer 50 is connected to the bar code issue server 10 that initially issued the now read bar code in order to grant service approval while transmitting appropriate information about transaction statements to the bar code issue server 10 so as to make a payment.

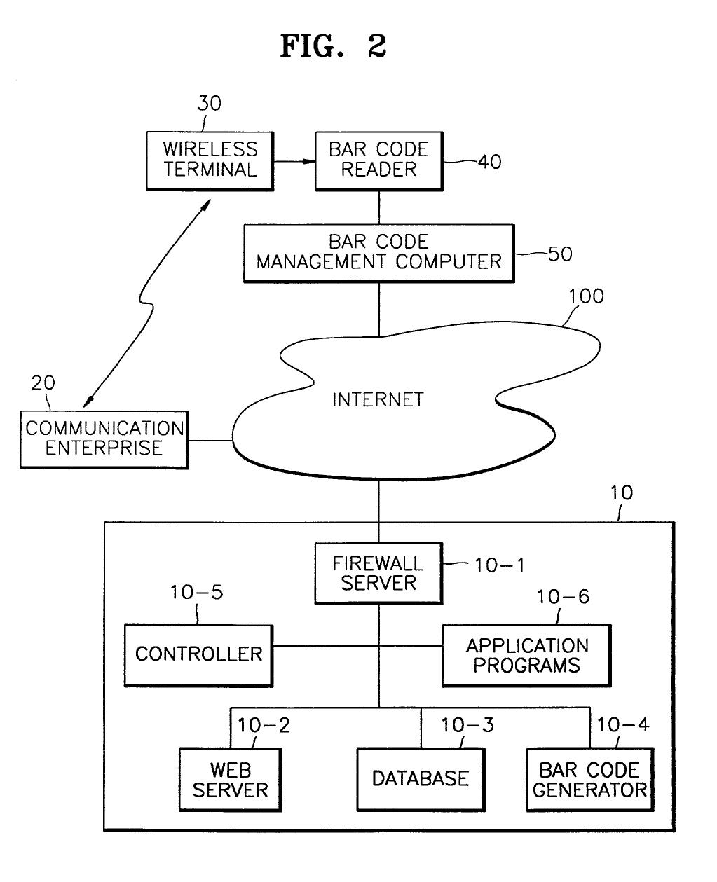

The thus-constructed business model according to the present invention will now be described in detail with reference to FIG. 2. Referring to FIG. 2, an information service system using a bar code at the wireless terminal 30 according to the present invention includes at least one interconnection through the Internet 100, the bar code issue server 10, the communication enterprise 20, the wireless terminal 30, the bar code reader 40, and the bar code management computer 50. The wireless terminal 30 enables wireless telephone services, and contains hardware and software which provide a wide variety of services by connecting to the Internet 100 using wireless communication. The communication enterprise 20 accesses a specific web site on the Internet 100 in response to the request received from the wireless terminal 30, modulates data transmitted from the accessed web site, and transmits the modulated data to the wireless terminal 30 through a base station. A bar code is read by the bar code reader 40 established in a member store interconnected with bar code issue server 10.

The bar code management computer 50 comprises a central system of a member store of the bar code issue server 10, contains a program which analyzes the bar code read by the bar code reader 40, searches for an address of a server issuing a bar code, performs a request for information related to the bar code, and performs service approval by connecting to the bar code issue server 10 having the searched address.

The bar code issue server 10 includes a firewall server 10-1, a web server 10-2, a database 10-3, a bar code generator 10-4, a controller 10-5, and application programs 10-6. The Internet 100 is a global network connecting millions of computers by a web. To provide the user of the wireless terminal 30 with Internet services through the communication enterprise 20, an Internet Protocol (IP) address is assigned using a Point-to-Point Protocol (PPP) through software for connecting a computer to the Internet 100, through a World Wide Web (WWW) browser. In this case, to make it easy to access the WWW services, web browsers such as Netscape Navigator® and Microsoft Internet Explorer® are employed to access a server address of a web site to receive desired information. According to the present invention, the wireless terminal 30 is connected to the bar code issue server 10 at one of web sites provided by the Internet 100 through the communication enterprise 20.

The configuration of the bar code issue server 10 will now be described. The firewall server 10-1 is constituted by hardware and/or software for protecting resources within the bar code issue server 10 and preventing inflow of external harmful information when exchanging information over the Internet. For example, a program for limiting unauthorized access using an IP address, a user authentication number, and a port number may be employed to prevent unauthorized release of internal information. The web server 10-2 provides information services to the wireless terminal 30 and the bar code management computer 50 connected to the bar code issue server 10 through the Internet 100 through a web browser. That is, the web server 10-2 sends information related to bar code services to the wireless terminal 30 and the bar code management computer 50 by a transmission protocol commonly used on the Internet 100.

The database 10-3 stores subscriber information and a variety of bar code service information for providing bar codes to subscribers. For example, financial information such as banking transaction information, stock information, e-coin information, coupon information, and mileage points, and other service information such as hospital records, family information, certification documents, and membership information are stored in the database 10-3. Furthermore, subscriber information of enterprises affiliated with the bar code issue server 10 is stored therein.

The bar code generator 10-4 generates an unique bar code in order to query a computer network for a user's personal information, a payment method, and other desired information. According to a request by the user, the user's unique bar code can be generated, or if necessary, information related to particular items requested by the user can be generated as bar code symbols. The controller 10-5 entirely controls the bar code issue server 10, searches the database 10-3 for corresponding information according to a request by the user to read therefrom, controls the bar code generator 10-4 to generate a bar code corresponding to the read information, transmits the bar code to the user's wireless terminal 30 connected thereto, and analyzes the received bar code to execute a series of processes for executing approval for a corresponding service.

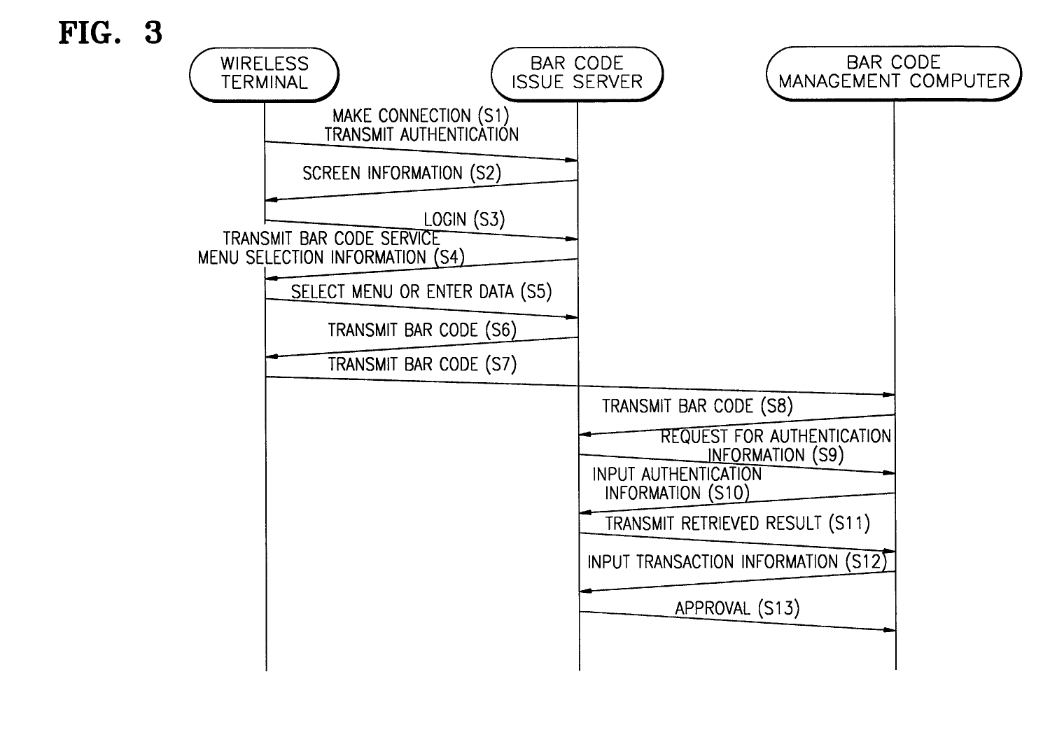

Next, a process for offering a bar code service by the bar code issue server 10 using the wireless terminal 30 will be described with reference to FIGS. 1 and 3. If the user of the wireless terminal 30 wishes to be offered a bar code issue service, the wireless terminal 30 executes a program for connecting to the Internet. Then, the wireless terminal 30 is assigned an IP address from the communication enterprise 20 so as to provide Internet services through the communication enterprise 20. When the wireless terminal 30 is connected to the Internet, if the domain address of the bar code issue server 10 is input at the wireless terminal 30, the wireless terminal 30 is connected to the bar code issue server 10 (S1). If the wireless terminal 30 is connected to the bar code issue server 10, then the bar code issue server 10 transmits authentication screen information to the connected wireless terminal 30 (S2).

Then, the user of the wireless terminal 30 enters an identification number (“ID”) and password using an input means such as a key button to perform a login procedure (S3). The logged-in ID and password are compared with the user information stored in the database 10-3 to ensure that both are the same, and if the login is accepted, then the bar code issue server 10 sends bar code service selection menu information to the wireless terminal 30 through the communication enterprise 20 (S4). If the login is not accepted, then the bar code issue server 10 sends a message indicating that he or she is an unauthorized user, requiring that a re-login attempt be made or registration of the subscriber be completed prior to authorization. The bar code selection menu information includes menu information such as a menu for user authentication, a coupon service, membership, and financial information.

The user of the wireless terminal 30 selects a desired menu or enters data related to desired information using a key button (S5). The data entered at the wireless terminal 30 is transmitted to the bar code issue server 10 through the communication enterprise 20. The transmitted data is interpreted by the bar code issue server 10, and corresponding service information is read from the database 10-3. Then, after the bar code generator 10-4 is controlled to convert the corresponding service information into a bar code, the bar code is transmitted to the wireless terminal 30 through the communication enterprise 20 (S6). Thus, the bar code for desired information is transmitted to the wireless terminal 30 and stored in an internal memory thereof (not shown), and the transmitted bar code is decoded and output through a display means of the wireless terminal 30.

In the case where the user uses the offered service at a bar code member store connected to the bar code issue server 10, the bar code received through the wireless terminal 30 output at a display window of the wireless terminal 30 is read by the bar code reader 40 installed at the bar code member store. The read bar code is then transmitted to the bar code management computer 50 established at the central system of the bar code member store (S7). Then, the bar code management computer 50 interprets the bar code read by the bar code reader 40 and searches an internal database (not shown) for the domain address of the bar code issue server 10 that issues the corresponding bar code. After connecting to the bar code issue server 10 that issues the corresponding bar code, the bar code management computer 50 requests the bar code issue server 10 to send analysis information about the corresponding bar code and transfers bar code transmitted to the bar code management computer 50 to the bar code issue server 10 (S8)

Then, the bar code issue server 10 requests the bar code management computer 50 to send the user's authentication information so as to ensure that the user who requests issuance of the corresponding bar code is authorized (S9). When the user authentication information is input from the bar code management computer 50 (S10), the bar code issue server 10 determines whether or not the input authentication information is the same as that stored in the database 10-4. If both are the same, information corresponding to the transmitted bar code is read from the database 10-3 and then transmitted to the bar code management computer 50 of the member store requesting the analysis information (S11).

Then, after confirming the received bar code analysis information, the bar code management computer 50 inputs transaction information to the bar code issue server 10 according to the user's request (S12). The bar code issue server 10 updates user bar code information stored in the database 10-3 according to the input transaction information and then transmits data indicative of a transaction approval to the bar code management computer 50 (S13). Through this process, the user of the wireless terminal 30 can be offered a wide variety of information services including personal information and financial information using the bar code service.

As described in the foregoing, the present invention constructs a bar code system such that various services may be offered through a bar code system associated with a bar code issue server using at least one bar code transmitted to a wireless terminal through the Internet. Accordingly, the present invention provides for various business services on line while implementing a conventional bar code system with few changes. Second, the present invention offers a bar code service through the wireless terminal, thereby allowing for excellent mobility compared with the conventional fixed location bar code system. Third, the present invention can provide a marketing database for integrally managing information through a single bar code issue server. Fourth, the present invention allows an enterprise to easily handle a variety of authentication procedures through the on line network.

What is claimed is:

1. A bar code issue server for providing a bar code service over a network, the bar code issue server comprising:
a database operable for storing subscriber information and bar code service information pertaining to at least one subscriber;
a web server operable for transmitting and receiving information by a transmission protocol commonly used on the network;
the web server transmitting to one of a user terminal and a bar code management system information processed in response to a bar code related service request from one of the user terminal and the bar code management system;
a bar code generator operable for generating a first bar code corresponding to the information processed in response to the bar code related service requested by the user terminal; and
a controller operable for managing the database and controlling the bar code issue server such that the controller analyzes the bar code related service request information and controls the bar code generator to generate a bar code corresponding to the at least one subscriber requesting the bar code related service and operable for executing an authentication process for a second bar code received from the bar code management system.

2. The bar code issue server of claim 1, wherein each of the first and second bar codes at least includes subscriber information and business related information.

3. The bar code issue server of claim 2, wherein the business related information at least includes financial information pertaining to the subscriber.

4. An information service system using a bar code over a network, the system comprising:
a bar code management device;
a wireless terminal including hardware and software for transmitting/receiving information by connecting to the network through a wireless communication system;
a bar code issue server including a database, operable for storing predetermined bar code service information pertaining to a registered subscriber, generating a bar code corresponding to bar code related service information requested by a registered subscriber, transmitting the generated bar code to the registered subscriber's wireless terminal, analyzing a bar code received from the bar code management device, in order to transmit information corresponding to the analyzed result to the bar code management device, and determining the approval of a requested transaction in order to transmit appropriate authorization information; and
the bar code management device including a bar code reader operable for reading the bar code output at a display window of the wireless terminal, the bar code management device operable for interpreting the bar code read by the bar code reader, the bar code management device connected to the bar code issue server and operable for issuing the corresponding bar code and to request transaction approval while transmitting the information related to the read bar code.

5. An information service method using a bar code issue server over a network, the method comprising the steps of:
(a) receiving data at the bar code issue server comprising predetermined service information corresponding to a request to issue a first bar code from a user terminal connected to the bar code issue server;
(b) analyzing at the bar code issue server the information requested in step (a) to generate a first bar code corresponding to the analyzed information; and
(c) transmitting from the bar code issue server the first bar code generated in step (b) to the user terminal, connected to the bar code issue server, that transmits the request to issue the bar code.

6. The method of claim 5, wherein the user terminal connects to the bar code issue server, and the bar code issue server performs an authentication step identifying a registered subscriber before issuing the bar code.

7. The method of claim 5, further comprising the step of analyzing at a bar code management device a second bar code and transmitting from the bar code management device to the bar code issue server information related to a transaction approval while sending from the bar code management device to the bar code issue server a request to check the second bar code.

8. The method of claim 7, further including an authentication step for determining at the bar code issue server whether a user is an authorized user prior to giving the transaction approval.

9. A method of providing a bar code information service by a communication enterprise of an information service system using a bar code, the method comprising the steps of:
(a) connecting through the communication enterprise a bar code issue server in response to a request from a wireless terminal;
(b) requesting from the wireless terminal through the communication enterprise the bar code issue server to send through the communication enterprise a bar code corresponding to specific information pertaining to a user of the wireless terminal;
(c) receiving at the communication enterprise the bar code issued by the bar code issue server in response to the request made in step (b); and
(d) transmitting from the communication enterprise the bar code received in step (c) to the wireless terminal.

10. An information service method performed in a bar code management device of an information service system using a bar code, the method comprising the steps of:
(a) reading in a bar code management device a bar code issued in the information service system and displayed on a display means of a wireless terminal;
(b) searching in the bar code management device for issuer information about the bar code read in step (a) and its corresponding issue server;
(c) connecting from the bar code management device to the corresponding issue server searched in step (b) to request the server to send analyzed information corresponding to the bar code read in the step (a); and
(d) receiving at the bar code management device the analyzed information from the corresponding issue server.

11. A method for receiving a bar code information service of an information service system using a bar code and a user terminal, the method comprising the steps of
(a) connecting the user terminal to a bar code issue server and providing the bar code information service to the user terminal from the issue server in response to a user's request from the user terminal to the issue server;
(b) requesting from the user terminal the bar code issue server to transmit to the user terminal a bar code corresponding to specific information pertaining to a registered subscriber; and
(c) receiving at the user terminal a bar code issued from the bar code issue server in response to the request made in step (b).

12. The method of claim 11, wherein the bar code transmitted to the user terminal in step (c) is output to a display means of the user terminal.

13. The method of claim 12, further comprising the step (d) of the user receiving a service corresponding to the bar code from the bar code issue server transmitted through a bar code management device of a member store registered in the bar code issue server, the step (d) initiated by scanning at the bar code management device the bar code output to the display means of the user terminal.
